(19) United States
(12) Patent Application Publication
(10) Pub. No.: US 2022/0349301 A1
(43) Pub. Date: Nov. 3, 2022

(54) DETERMINING A RISK OF STUCK PIPES DURING WELL DRILLING OPERATIONS

(71) Applicant: Saudi Arabian Oil Company, Dhahran (SA)

(72) Inventors: Bader M. Alotaibi, Dhahran (SA); Peter Ido Egbe, Abqaiq (SA); Majed A. Alzahrani, Dammam (SA)

(21) Appl. No.: 17/245,559

(22) Filed: Apr. 30, 2021

(51) Int. Cl. E21B 49/00; E21B 47/022

(52) U.S. Cl. CPC E21B 49/003; E21B 47/022

(57) ABSTRACT

In an example method, a system obtains, during a first subterranean drilling operation, first data indicating one or more characteristics of a drill bit of a drilling system, second data including sensor measurements regarding the drilling system, and third data indicating historical information regarding one or more additional subterranean drilling operations. The system determines a first metric based on the first data, a second metric based on the second data, and a third metric based on the third data. Further, the system determines a fourth metric based on the first metric, the second metric, and the third metric, where the fourth metric is indicative of a risk of a stuck pipe in the drilling system during the first subterranean drilling operation. The system generates a graphical user interface for presentation to a user, including an indication of the fourth metric.

### TECHNICAL FIELD

The disclosure relates to systems and methods for determining a risk of stuck pipes during well drilling operations.

### BACKGROUND

A well is used to bring natural resources, such as oil or natural gas, from a subsurface formation to the surface of the earth. A well can be constructed and utilized according to several stages, including a drilling stage, a completion stage, and a production stage.

During the drilling stage, a wellbore is formed by drilling a hole through the surface of the earth and through a portion of the subsurface formation, such that the contents of the subsurface formation can be accessed. Further, the wellbore can be reinforced, for example by installing casing or pipe along its length.

During the completion stage, the well is made ready for production. For example, the bottom of the wellbore can be prepared to particular specifications. As another example, production tubing and other downhole tools can be installed in or around the wellbore to facilitate the extraction of natural resources from the well.

During the production stage, natural resources are extracted from the subsurface formation and brought to the surface of the earth. For example, oil or natural gas contained within the subsurface formation can be brought to the surface of the earth, such that they can be refined and used as sources of energy or used as a part of other industrial applications.

### SUMMARY

In some implementations, a computer system can be used to monitor a drilling system during a well drilling process and provide information to a user to guide the operation of the drilling system.

As an example, a drilling system can include a drill string having one or more pipes to transport fluids into and/or out of a wellbore. However, during the drilling process, a pipe may become stuck in the wellbore, such that movement of the pipe is partially or entirely restricted. In some cases, a stuck pipe can cause damage to the drill string or the loss of the drill string.

To eliminate or otherwise reduce the occurrence of stuck pipes, a computer system can continuously monitor the drilling system during operation, determine a risk of a stuck pipe, and notify an operator if the risk of a stuck pipe is sufficiently high, prior to the pipe becoming stuck. This enables the operator to preemptively avoid the occurrence of a stuck pipe, such as by moving the drill string in a particular manner, changing one or more operational parameters of the drilling system, and/or discontinuing operation of the drilling system.

In some implementations, the systems and techniques described herein can provide various technical benefits to drilling systems. For example, the systems and techniques described herein can improve the reliability of a drilling system, such as by reducing or eliminating the risk of damage to the drilling system during operation. Further, the systems and techniques described herein can improve the speed by which wells can be constructed, such as by reducing or eliminating the need to suspend drilling operations to free a stuck pipe.

In an aspect, a method includes obtaining, using one or more processors during a first subterranean drilling operation, first data indicating at least one of a characteristic of a drill bit of a drilling system or a characteristic of a wellbore associated with the first subterranean drilling operation; determining, using the one or more processors, a first metric based on the first data; obtaining, using the one or more processors during the first subterranean drilling operation, second data including sensor measurements regarding the drilling system; determining, using the one or more processors, a second metric based on the second data; obtaining, using the one or more processor, third data indicating historical information regarding one or more additional subterranean drilling operations; determining, using the one or more processors, a third metric based on the third data; determining, using the one or more processors, a fourth metric based on the first metric, the second metric, and the third metric, where the fourth metric is indicative of a risk of a stuck pipe in the drilling system during the first subterranean drilling operation; and generating, using the one or more processors, a graphical user interface for presentation to a user, where the graphical user interface includes an indication of the fourth metric.

Implementations of this aspect can includes one or more of the following features.

In some implementations, the fourth metric can be a weighted sum of the first metric, the second metric, and the third metric.

In some implementations, the method can include determining, using the one or more processors, that the fourth metric satisfies one or more alert criteria; and responsive to determining that the fourth metric satisfies the one or more alert criteria, generating an alert using the graphical user interface.

In some implementations, the one or more alert criteria can include at least one of a first criterion that the fourth metric exceeds a threshold value for at least a first threshold length of time, a second criterion that an additional alert has not been generated within a second threshold length of time in the past, or a third criterion that the first data, the second data, and the third data satisfy a minimum quality threshold.

In some implementations, the first data and the second data can be obtained continuously during the first subterranean drilling operation.

In some implementations, the first metric, the second metric, and the fourth metric can be determined continuously during the first subterranean drilling operation.

In some implementations, the first data can include at least one of an indication of a trajectory of the wellbore, an indication of an operational state of a bit drill of the drilling system during the first subterranean drilling operation, or a location of a drill string of the drilling system during the first subterranean drilling operation.

In some implementations, the first data can include an indication whether the location of the drill string is within one or more pre-determined regions.

In some implementations, the sensor measurements can include at least one of first measurements indicating a length of time that a string of the drilling system has been stationary during the first subterranean drilling operation, second measurements indicating a torque generated by the drilling system during the first subterranean drilling operation, third measurements indicating a drag of the drilling system during the first subterranean drilling operation, fourth measurements indicating a stand pipe pressure of the drilling system during the first subterranean drilling operation, or fifth measurements indicating a hook load of the drilling system during the first subterranean drilling operation.

In some implementations, determining the second metric can include determining a change in at least one of the second measurement, the third measurement, the fourth measurement, or the fifth measurement over time.

In some implementations, the third data can include, for each of the one or more additional subterranean drilling operations a depth of the additional drilling operation, and an indication whether a stuck pipe occurred at that depth during the additional drilling operation.

Other implementations are directed to systems, devices, and devices for performing some or all of the method. Other implementations are directed to one or more non-transitory computer-readable media including one or more sequences of instructions which when executed by one or more processors causes the performance of some or all of the method.

The details of one or more embodiments are set forth in the accompanying drawings and the description. Other features and advantages will be apparent from the description and drawings, and from the claims.

### BRIEF DESCRIPTION OF DRAWINGS

FIG. 1 is a diagram of a system for performing drilling operations.

FIG. 2 is a diagram of an example drill monitoring system.

FIGS. 3A-3D are diagrams of example graphical user interfaces to present information regarding a drilling system to a user.

FIG. 4 is a flow chart diagram of an example processor for determining a risk of stuck pipes during a well drilling operation.

FIG. 5 is a schematic diagram of an example computer system.

### DETAILED DESCRIPTION

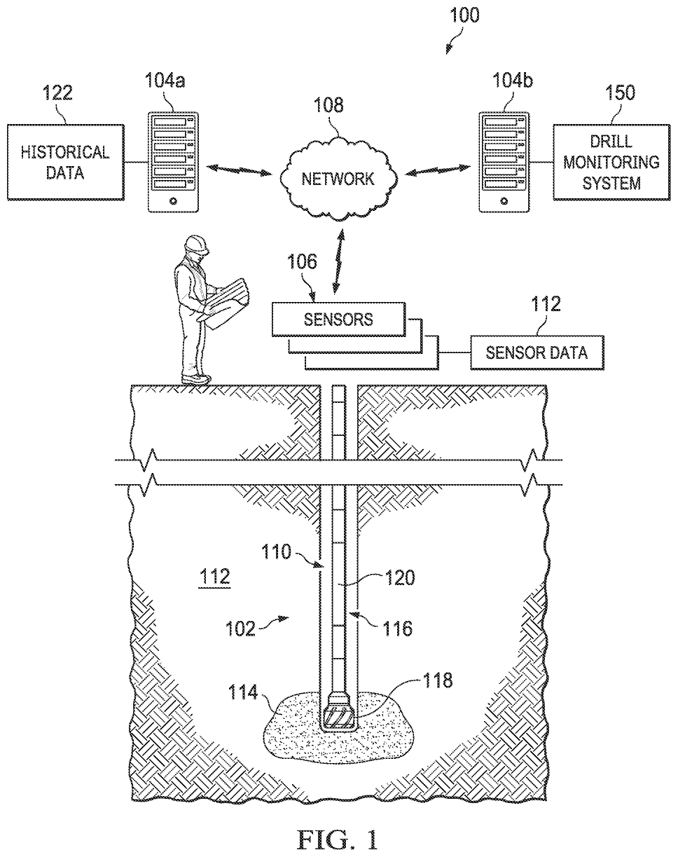

FIG. 1 shows an example system 100 for performing drilling operations, such as during a well construction process. The system 100 includes a drilling system 102, computer systems 104a and 104b, and sensors 106 communicatively coupled to one another through a network 108. Further, a drill monitoring system 150 is maintained on at least one of the computer systems (for example, the computer system 104b).

During an example operation of the system 100, the drilling system 102 is used to drill a wellbore 110 into the earth 112 (for example, to access natural resources in a subterranean formation 114, such as oil or natural gas). For instance, the drilling system 102 can include a drill string 116, which includes a drill bit 118 positioned at an end of one or more pipes 120. The drill bit 118 is placed against the earth 112, and cuts into the earth 112 to form the walls of the wellbore 110. Further, the drill bit 118 is guided through the earth 112 to define a particular trajectory for the wellbore 110. During the operation of the drill bit 118, fluid (for example, drilling fluid) is transported into the wellbore 110 from the surface of the earth 112 and/or out of the wellbore 110 to the surface of the earth 112 to facilitate the cutting of the earth 112.

During the drilling process, the pipe 120 may become stuck in the wellbore 110, such that movement of the pipe 120 is partially or entirely restricted. For example, the pipe 120 may come into contact with the walls of the wellbore 110 or substances in the wellbore 110, which may impede the motion of the pipe 120. As another example, the pipe 120 may experience particular pressures within the wellbore (for example, a pressure differential between the wellbore and the formation), which may cause the pipe 120 to push against the walls of the wellbore 110. In some cases, a stuck pipe 120 can cause damage to the drill string 116 and/or the loss of the drill string 116.

To eliminate or otherwise reduce the occurrence of stuck pipes, the drill monitoring system 150 can continuously monitor the drilling system 102 during operation, determine a risk of a stuck pipe, and notify an operator if the risk of a stuck pipe is sufficiently high, prior to the pipe 120 becoming stuck. Further, this process can be performed in real-time or substantially real-time. This enables the operator to preemptively avoid the occurrence of a stuck pipe, such as by moving the drilling string in a particular manner, changing one or more operational parameters of the drilling system, and/or discontinuing operation of the drilling system.

In some implementations, the drill monitoring system 150 can determine a risk of a stuck pipe based on sensor data 112 gathered by the sensors 106 during the operation of the drilling system 102. For instance, the sensors 106 can be positioned in or around the wellbore 110 and/or the drilling system 102, and can be configured to measure one or more properties of the earth 112, the subterranean formation 114, the wellbore 110, and/or the drilling system 102. Example sensors 106 include torque sensors, force sensors, weight sensors, mass sensors, acceleration sensors, orientation or gyroscopic sensors, drag sensors, pressure sensors, location sensors, temperature sensors, groundwater sensors, vapor sensors, optical sensors, vibrating or tuning fork sensors, ultrasonic sensors, float sensors, capacitance sensors, radar sensors, conductivity or resistance sensors, and any other sensors for measuring properties of the earth 112, the subterranean formation 114, the wellbore 110, and/or the drilling system 102. Example sensor data 112 is described in further detail below.

Further, the drill monitoring system 150 can determine a risk of a stuck pipe based on historical data 122 regarding one or more other previously conducted drilling operations. As an example, the historical data 122 can include sensor data gathered during each of the previously conducted drilling operations (for example, sensor data similar to the sensor data 112). As another example, the historical data 122 can include the location of each of the previously conducted drilling operations. As another example, the historical data 122 can include information regarding the type and/or configuration of the drilling equipment that was used to perform each of the previously conducted drilling operations. As another example, the historical data 122 can include information regarding the wellbore that was formed during each of the previously conducted drilling operations, such as the dimensions and trajectory of the wellbore. As another example, the historical data 122 can indicate whether a stuck pipe was encountered during each of the previously conducted drilling operations, and information regarding the cause of the stuck pipe. Example historical data 122 is described in further detail below.

In some implementations, the drill monitoring system 150 can continuously receive the sensor data 112 and/or historical data 122 during the drilling process, and continuously determine a risk of a stuck pipe based on the received data. The drill monitoring system 150 can present an indication of the risk to a user (for example, an operator of the drilling system 102), such that the user is informed regarding the risk through the operation of the drilling system 102. Further, the drill monitoring system 150 can present an alert or notification to the user if the risk is sufficiently high, such that the user can take corrective action prior to the occurrence of a stuck pipe. In some implementations, the drill monitoring system 150 can present information using a graphical user interface (for example, displayed using the computer system 104b and/or some other computer system).

In some implementations, the drill monitoring system 150 can calculate a numerical Stuck Pipe Index (SPI) metric that indicates the risk of a stuck pipe at a particular point in time. For example, an SPI metric having a higher value can indicate that the risk of a stuck pipe is higher at that time, whereas an SPI metric having a lower value can indicate that the risk of a stuck pipe is lower at that time. Further, the drill monitoring system 150 can continuously recalculate the SPI metric during the drilling process (for example, in real-time or substantially real-time), such that the SPI metric is updated to reflect the current conditions of the drilling system 102.

In some implementations, the drill monitoring system 150 can present the SPI metric to a user, such that the user is informed regarding the risk of a stuck pipe through the operation of the drilling system 102. Further, the drill monitoring system 150 can present an alert or notification to the user if the SPI index is sufficiently high (for example, greater than a particular threshold value), such that the user can take corrective action prior to the occurrence of a stuck pipe.

Further details regarding the calculation of the SPI metric are described below.

Each of the computer systems 104a and 104b can include any number of electronic device that are configured to receive, process, and transmit data. Examples of the computer systems 104a and 104b include client computing devices (such as desktop computers or notebook computers), server computing devices (such as server computers or cloud computing systems), mobile computing devices (such as cellular phones, smartphones, tablets, personal data assistants, notebook computers with networking capability), wearable computing devices (such as a smart phone or a headset), and other computing devices capable of receiving, processing, and transmitting data. In some implementations, the computer systems 104a and 104b can include computing devices that operate using one or more operating systems (as examples, Microsoft Windows, Apple macOS, Linux, Unix, Google Android, and Apple iOS, among others) and one or more architectures (as examples, x86, PowerPC, and ARM, among others). In some implementations, one or more of the computer system 104a and 104b need not be located locally with respect to the rest of the system 100, and one or more of the computer systems 104a-104d can be located in one or more remote physical locations.

Each the computer systems 104a and 104b can include a respective user interface that enables users interact with the computer system 104a and 104b and the drill monitoring system 150, such as to view data from one or more of the computer systems 104a and 104b and the drill monitoring system 150, transmit data from one computer system to another, or to issue commands to one or more of the computer systems 104a and 104b and the drill monitoring system 150. Commands can include, for example, any user instruction to one or more of the computer system 104a and 104b or the drill monitoring system 150 to perform particular operations or tasks. In some implementations, a user can install a software application onto one or more of the computer systems 104a and 104b to facilitate performance of these tasks.

In FIG. 1, the computer systems 104a and 104b are illustrated as respective single components. However, in practice, the computer systems 104a and 104b can be implemented on one or more computing devices (for example, each computing device including at least one processor such as a microprocessor or microcontroller). As an example, the computer system 104b can be a single computing device that is connected to the network 108, and the drill monitoring system 150 can be maintained and operated on the single computing device. As another example, the computer system 104b can include multiple computing devices that are connected to the network 108, and the drill monitoring system 150 can be maintained and operated on some or all of the computing devices. For instance, the computer system 104b can include several computing devices, and the drill monitoring system 150 can be distributive on one or more of these computing devices.

The network 108 can be any communications network through which data can be transferred and shared. For example, the network 108 can be a local area network (LAN) or a wide-area network (WAN), such as the Internet. The network 108 can be implemented using various networking interfaces, for instance wireless networking interfaces (such as Wi-Fi, Bluetooth, or infrared) or wired networking interfaces (such as Ethernet or serial connection). The network 108 also can include combinations of more than one network, and can be implemented using one or more networking interfaces.

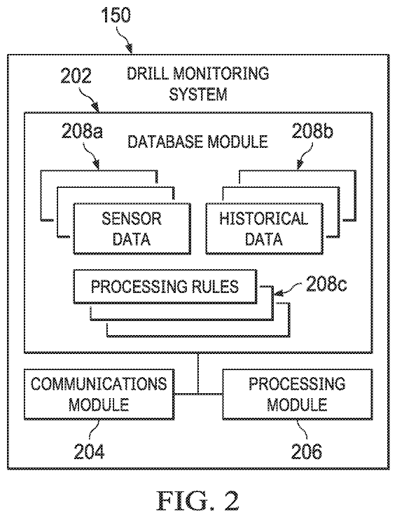

FIG. 2 shows various aspects of the drill monitoring system 150. The drill monitoring system 150 includes several modules that perform particular functions related to the operation of the system 100. For example, the drill monitoring system 150 can include a database module 202, a communications module 204, and a processing module 206.

The database module 202 maintains information related to monitoring a drilling system (for example, the drilling system 102) and determining a risk of a stuck pipe during the operation of the drilling system.

As an example, the database module 202 can store sensor data 208a regarding a current or anticipated drilling operation. The sensor data 208a can be similar to the sensor data 112 described with respect to FIG. 1. For example, the sensor data can include measurements obtained by the sensors 106 regarding one or more of the proprieties of the earth 112, the subterranean formation 114, the wellbore 110, and/or the drilling system 102.

In some implementations, the sensor data 208a can be classified according to the operational state of the drilling system 102 at the time that the sensor data 208a was collected. As an example, each measurement can be stored as a respective data record. Further, each data record can be classified into one of several classes based on whether the drill bit is on the bottom of the wellbore, whether a tripping process is being performed by the drilling system (for example, removing and/or replacing pipe from the drill string), whether the drilling system is actively drilling, whether the drill string is stationary, whether the drilling system is performing a circulation process, and/or whether the drilling system is being operated in an in case hole (for example, a wellbore with casing installed) or an open hole (or example, a wellbore that has not yet had casing installed).

Further, the database module 202 can store historical data 208b regarding one or more previously conducted drilling operations. The historical data 208b can be similar to the historical data 122 described with respect to FIG. 1. For example, the historical data 208b can include sensor data gathered during each of the previously conducted drilling operations. As another example, the historical data 208b can include the location of each of the previously conducted drilling operations, information regarding the type and/or configuration of the drilling equipment that was used to perform each of the previously conducted drilling operations, information regarding the wellbore that was formed during each of the previously conducted drilling operations, such as the dimensions and trajectory of the wellbore. As another example, the historical data 208b can indicate whether a stuck pipe was encountered during each of the previously conducted drilling operations, and information regarding the cause of the stuck pipe.

Further, the database module 202 can store processing rules 208c specifying how data in the database module 202 can be processed to determine a risk of a stuck pipe during a drill operation. For instance, as described above, the drilling monitoring system 150 can generate a SPI metric that indicates the risk of a stuck pipe at a particular point in time. The processing rules 208c can specify how the SPI metric is calculated, given particular sensor data 208a and historical data 208b.

As an example, the SPI metric can be calculated by calculating several sub-metrics based on the sensor data 208a and/or the historical data 208b, and determining a weighted sum of those sub-metrics. For instance, the SPI metric can be calculated using the function:

SPI=w₁x₁+w₂x₂+w₃x₃ (Eq. 1),

where SPI is the SPI metric; x₁, x₂ and x₃ are different respective sub-metrics calculated using the sensor data 208a and/or the historical data 208b; and w₁, w₂, and w₃ are weighting coefficients that weight the sub-metrics x₁, x₂ and x₃, respectively.

The sub-metric x₁ can represent a risk of a stuck pipe during a drilling operation based on historical information regarding one or more previously performed drilling operations. In some cases, the sub-metric x₁ may be referred to as a “prior experience risk” metric.

The sub-metric x₁ can be calculated based on information from both the sensor data 208a and the historical data 208b. For instance, the current depth of the drill string 116 (for example, the depth of the drill bit 118 below the surface of the earth 112) can be determined based on the sensor data 208a. Further, the historical data 208b can be analyzed to determine the percentage of previously performed drilling operations in which a stuck pipe was encountered at that depth. A numerical value for the sub-metric x₁ can be calculated based on this information

As an example, the sub-metric x₁ can be calculated using the function:

$${x}_{1} = \frac{{N}_{s t u c k}}{{N}_{t o t a l}} * 100 , \qquad ( Eq . 2 )$$

where N_{stuck} is the number of previously performed drilling operations that encountered a stuck pipe at the particular depth, and Nₜₒₜₐₗ is the total number of drilling operations that were performed at that depth. In some implementations, N_{stuck} and Nₜₒₜₐₗ can indicate drilling operations that were previously performed to form an offset well (for example, a well formed alongside the site of a proposed well, such as to obtain information to guide the formation of the proposed well).

The sub-metric x₂ can represent a risk of a stuck pipe during a drilling operation based on sensor measurements obtained regarding the drilling operation. In some cases, the sub-metric x₂ may be referred to as a “field symptoms” metric.

The sub-metric x₂ can be calculated based on information from the sensor data 208a. As an example, the value of the sub-metric x₂ can depend on the length of time that the drill string 116 has been stationary. In some implementations, the value of the sub-metric x₂ can increase with an increase in time that the drill string 116 has been stationary.

As another example, the value of the sub-metric x₂ can depend on the change in torque produced by the drilling system 102 (for example, by a motor or engine that drives the drill bit 118) over time. In some implementations, the value of the sub-metric x₂ can increase with an increase in torque over time. In some implementations, the value of the sub-metric x₂ can depend on the slope of a torque curve over time and a slope of a rotational speed of a motor or engine of the drilling system 102 (for example, in rotations per minute, RPM) over time, within a predefined window of time.

In some implementations, to reduce noise in the calculation of the sub-metric x₂, the value of the sub-metric x₂ can be gradually increased based on the length of time in which the slope of the torque is positive while the slope of the RPM is negative, or vice versa. For example, as this length of time increases, the value of the sub-metric x₂ can also increase.

As another example, the value of the sub-metric x₂ can depend on the change in stand pipe pressure of the drilling system 102 over time. The stand pipe pressure can refer to the total pressure loss in a system that occurs due to fluid friction. For instance, the stand pipe pressure can be expressed as the sum of pressure loss in the annulus of a wellbore, the pressure loss in the drill string, the pressure loss in bottom hole assembly (BHA), and the pressure loss across the drill bit. In some implementations, the value of the sub-metric x₂ can increase with an increase in the stand pipe pressure over time. In some implementations, the value of the sub-metric x₂ can depend on the slope of the stand pipe pressure over time and a slope of the flow rate of fluid through the pipe over time, within a predefined window of time.

In some implementations, to reduce noise in the calculation of the sub-metric x₂, the value of the sub-metric x₂ can be gradually increased based on the length of time in which the slope of the stand pipe pressure is positive while the slope of the flow rate is negative, or vice versa. For example, as this length of time increases, the value of the sub-metric x₂ can also increase.

As another example, the value of the sub-metric x₂ can depend on the torque and drag experienced by the drill string 116 over time. For example, during a planning process, an estimated slack-off weight and pick-up weight for the drill string 116 can be calculated. The slack-off weight can refer to the weight of the drill string when the drill string is inserted into the wellbore. The pick-up weight can refer to the weight of the drill string when the drill string is pulled from the wellbore. The value of the sub-metric x₂ can be increased with an increase in a deviation between the planned weights and the actual weights.

In some implementations, the pick-up window (for example, for measuring the pick-up weight) can start when a full stand has been drilled, the drill start starts moving upwards, and the Kelly (for example, a square or hexagonal rotating shaft on a drilling system that receives torque from the Kelly bushing rotary table and transfers it to the drill string) is down. Further, the pick-up window can close when the drill bit begins to move downward.

In some implementations, the slack-off window (for example, for measuring the slack-off weight) can start immediately after the pick-up window, and can close when the hook load drops significantly (for example, more than a threshold amount) or the flow rate through the pipes drop significantly (for example, more than a threshold amount). The hook load can refer to the actual weight of a drill string measured at the surface, accounting for buoyancy, friction and other factors in the wellbore.

In some implementations, the rate of change in drag between one or more slack-off windows or pick-up windows can be calculated and flagged based on the correlation between the two windows. Drag can refer to the hook load value due to axial forces, and the effect of friction, generated when the drill pipe moves or tends to move in the wellbore. In some implementations, a higher rate of change can correspond to a higher value for the sub-metric x₂, whereas a lower rate of change can correspond to a smaller value for the sub-metric x₂.

As another example, the value of the sub-metric x₂ can depend on the hook load of the drilling system 102 over time. For example, the value of sub-metric x₂ can depending on the rate of change of the maximum hook load between two hook load profiles. A hook load profile can be the interval between the hook load exceeding a particular cut-off weight (for example, a particular threshold weight) and the hook load decreasing back below the cut-off weight. The maximum hook load can be calculated for each hook load profile, and compared to one another over time. As described above, the hook load can refer to the actual weight of a drill string measured at the surface, accounting for buoyancy, friction and other factors in the wellbore. In some implementations, there is no limit on how long or short a hook load trip can be. In some implementations, the value of the sub-metric x₂ can increase by a particular amount (for example, a particular percentage) for every percentage of increase in the maximum hook load.

As another example, the value of the sub-metric x₂ can depend on one or more user defined risk factors. For instance, a user can specify customized logic that influences the value of the sub-metric x₂ based on any of the parameters or other data of the sensor data 208a and/or the historical data 208b.

As an example, the sensor data 208a can include measurements regarding the equivalent circulating density (ECD) during a drilling operation. The ECD can refer to the effective density exerted by a circulating fluid against a formation that takes into account the pressure drop in the annulus of the wellbore above the point being considered. A user can specify that a user defined risk factor can be calculated based on a particular user defined function, such as:

y=u(if(ECD>X,100,0) (Eq. 3),

where y is a user defined risk factor, u is a weighting coefficient, ECD is the measured equivalent circulating density, and X is a threshold value. The values of u and X can be selected empirically (for example, based on one or more experiments that determine a correlation between (i) the measured ECD, and (ii) the corresponding risk of a stuck pipe).

Although an example user defined risk factor is described above, this is merely an illustrative example. In practice, a user defined risk factor can be defined according to any parameter or other data included in the sensor data 208a and/or historical data 208b, and can be calculated based on any function.

In some implementations, the value of the sub-metric x₂ can calculated based on a weighted sum of the factors described above. For example, the sub-metric x₂ can be calculated using the function:

x₂=u₁y₁+u₂y₂+ . . . uₙyₙ (Eq. 4),

where each variable yᵢ corresponds to a different risk factor (for example, any of the risk factors described above). For example, each of the variables yᵢ can have a numerical value that indicates the risk of a stuck pipe (for example, calculated based on the techniques described above), where an increase in the value corresponds to an increase in the risk of a stuck pipe. Further, each of the variables yᵢ can be weighted by a respective weighting coefficient uᵢ. The values of yᵢ and uᵢ can be selected empirically (for example, based on one or more experiments that determine a correlation between (i) each of the risk factors, and (ii) the corresponding risk of a stuck pipe).

The sub-metric x₃ can represent a risk of a stuck pipe during a drilling operation based on the properties of the wellbore. In some cases, the sub-metric x₃ may be referred to as a “trouble zone” metric.

The sub-metric x₃ can be calculated based on information from the sensor data 208a. For instance, based on the sensor data 208a, a determination can be based regarding the geometry or trajectory of the wellbore 110, the operational state of the drill bit 118, and the location of the drill string 116 within the earth 112. A numerical value for the sub-metric x₃ can be calculated based on this information.

As an example, the sub-metric x₃ can be calculated using the function:

x₃=v₁z₁+v₂z₂+v₃z₃ (Eq. 5).

The variable z₁ represents the geometry or trajectory of the wellbore 110. For example, z₁ can be different numerical values, depending on the degree of inclination of the wellbore 110 and/or whether the wellbore 110 has a dogleg trajectory. The inclination of a wellbore can refer to the angle between the trajectory of the wellbore and a vertical axis. For example, a wellbore having a vertical trajectory can have a 0° inclination, whereas a wellbore having a horizontal trajectory can have a 90° inclination. A dogleg trajectory can refer to a trajectory the bends sharply at one or more points along the trajectory. In some implementations, a greater degree of incline and/or a dogleg trajectory can correspond to a higher numerical value for z₁, whereas a lesser degree of incline and/or an absence of a dogleg trajectory can correspond to a lower numerical value for z₁.

The value for z₁, given a particular geometry or trajectory of the wellbore 110, can be determined empirically (for example, based on one or more experiments that determine a correlation between (i) each of the individual geometries or trajectories of a wellbore, and (ii) the corresponding risk of a stuck pipe). Further, a weighting coefficient v₁ can be determined empirically (for example, based on one or more experiments that determine a general correlation between z₁ and the corresponding risk of a stuck pipe).

The variable z₂ represents the operational state of the drill bit 118. For example, z₂ can be different numerical values, depending on whether the drill bit is currently performing drilling operations, whether the drill bit is currently running within the wellbore (for example, “running in hole”), or whether the drill bit is currently running outside of the wellbore (for example, “running out of hole”). The value for z₂, given a particular operational state of the drill bit, can be determined empirically (for example, based on one or more experiments that determine a correlation between (i) each of the individual operational state of the drill bit, and (ii) the corresponding risk of a stuck pipe). Further, a weighting coefficient v₂ can be determined empirically (for example, based on one or more experiments that determine a general correlation between z₂ and the corresponding risk of a stuck pipe).

The variable z₃ represents the location of the drill string 116 within the earth 112, such as whether the drill string is location at a depth that is expected to increase the risk of stuck pipes (for example, a “trouble zone”). For instance, based on the historical data 122 (for example, historical data regarding an offset well previously formed alongside the current wellbore), the drill monitoring system 150 can determine that at a particular location, certain depth intervals between the earth 112 are known to have high pressure, losses, or other characteristics that increase the risk of a stuck pipe. If the drill string is within such a depth interval, the z₃ can be assigned a first numerical value. If the drill string is not within such a depth interval, the z₃ can be assigned a second numerical value (for example, a value lower than the first numerical value). The value for z₃, given a location of the drill string 116 relative to trouble zone, can be determined empirically (for example, based on one or more experiments that determine a correlation between (i) the location of a drill string relative to a trouble zone, and (ii) the corresponding risk of a stuck pipe). Further, a weighting coefficient v₃ can be determined empirically (for example, based on one or more experiments that determine a general correlation between z₃ and the corresponding risk of a stuck pipe).

The processing rules 208c can be used to define one or more of the calculation techniques described above, such that the SPI metric can be calculated in an objective manner that is particularly suitable for performance by a computer. Further, the processing rules 208c enable a computer system to perform tasks that eliminate or otherwise reduce a reliance on subjective human input.

As described above, the drill monitoring system 150 also includes a communications module 204. The communications module 204 allows for the transmission of data to and from the drill monitoring system 150. For example, the communications module 204 can be communicatively connected to the network 108, such that it can transmit data to and receive data from each of the computer systems 104a and 104b and the sensors 106. Information received from the computer systems 104a and 104b and sensors 106 can be processed (for example, using the processing module 206) and stored (for example, using the database module 202).

As described above, the drill monitoring system 150 also includes a processing module 206. The processing module 206 processes data stored or otherwise accessible to the drill monitoring system 150. For instance, the processing module 206 can determine a risk of a stuck pipe during a drilling operation based on the sensor data 208a, the historical data 208b, and the processing rules 208c (for example, as described above). Further, the processing module 206 can generate one or more graphical user interfaces to present information to a user and/or generate one or more alerts or notifications to a user prompting the user to take correction action prior to the occurrence of a stuck pipe.

As described above, the drill monitoring system 150 can present the SPI metric to a user, such that the user is informed regarding the risk of a stuck pipe through the operation of the drilling system 102. Further, the drill monitoring system 150 can present an alert or notification to the user if certain alert criteria are met.

In some implementations, the drill monitoring system 150 can present an alert or notification to the user if the SPI metric is greater than a particular threshold value.

In some implementations, the drill monitoring system 150 can present an alert or notification to the user if (i) the SPI metric is greater than a threshold value for a particular threshold value, (ii) an alert was not previously presented to the user within a particular threshold length of time in the past, and (iii) the quality of the data used to calculate the SPI metric satisfies a particular minimum quality threshold (or some sub-combination of these criteria). The quality of data can depend, for example, on the completeness of the data (for example, whether sensor measurements are available throughout a particular interval of time, or whether one or more sensor measurements are missing during certain times due to data corruption or malfunctioning sensors) and/or the amount of noise in the data.

In some implementations, the drill monitoring system 150 can determine the quality of the data (for example, the sensor data 208a and/or the historical data 208b) prior to processing the data to determine the risk of a stuck pipe. If the quality of the data is sufficiently high (for example, greater than or equal to a minimum quality level), the drill monitoring system 150 can proceed with processing the data. If the quality of the data is not sufficiently high (for example, less than the minimum quality level), the drill monitoring system 150 can discontinue processing the data until higher quality data is received.

In some implementations, the drill monitoring system 150 can also identify one or more causes of an elevated risk for a stuck pipe, and identify that cause to a user. For example, the drill monitoring system 150 can identify the sub-metric x₁, x₂ and x₃ having the highest value (either alone, or after each of the sub-metrics has been weighted by its respective weighting coefficient w₁, w₂ and w₃), and identify that sub-metric to the user via a graphical user interface.

As an example, if w₁x₁ is equal to 0.5, w₂x₂ is equal to 0.1, and w₃x₃ is equal to 0.2, the drill monitoring system 150 can identify the weighted sub-metric w₁x₁ as the primary cause of the risk of stuck pipes. Accordingly, the primary risk corresponds with a “prior risk experience” based on historical information regarding one or more previously performed drilling operations.

As another example, if w₁x₁ is equal to 0.1, w₂x₂ is equal to 0.6, and w₃x₃ is equal to 0.3, the drill monitoring system 150 can identify the weighted sub-metric w₂x₂ as the primary cause of the risk of stuck pipes. Accordingly, the primary risk corresponds with a “field symptom” risk based on sensor measurements obtained regarding the current drilling operation.

As another example, if w₁x₁ is equal to 0.1, w₂x₂ is equal to 0.2, and w₃x₃ is equal to 0.7, the drill monitoring system 150 can identify the weighted sub-metric w₃x₃ as the primary cause of the risk of stuck pipes. Accordingly, the primary risk corresponds with a “trouble zone” risk based on the properties of the wellbore.

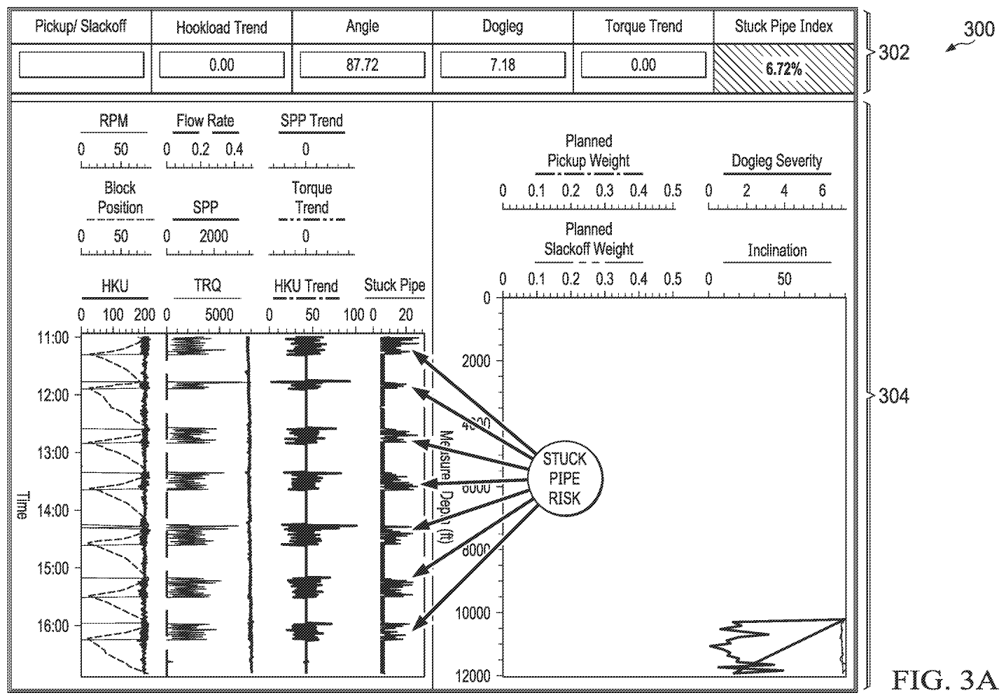

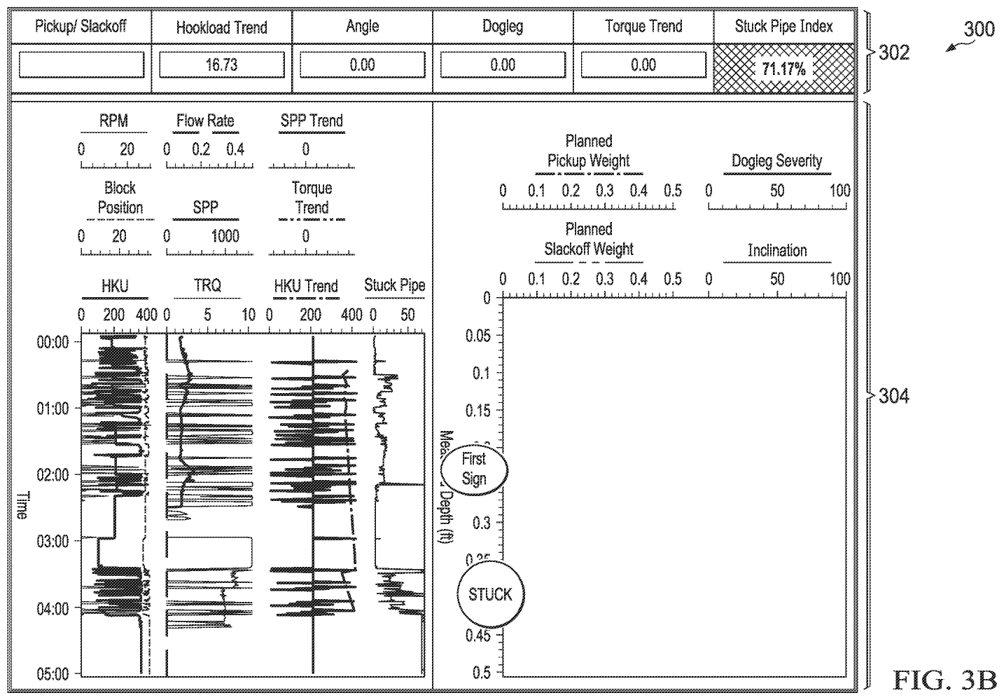

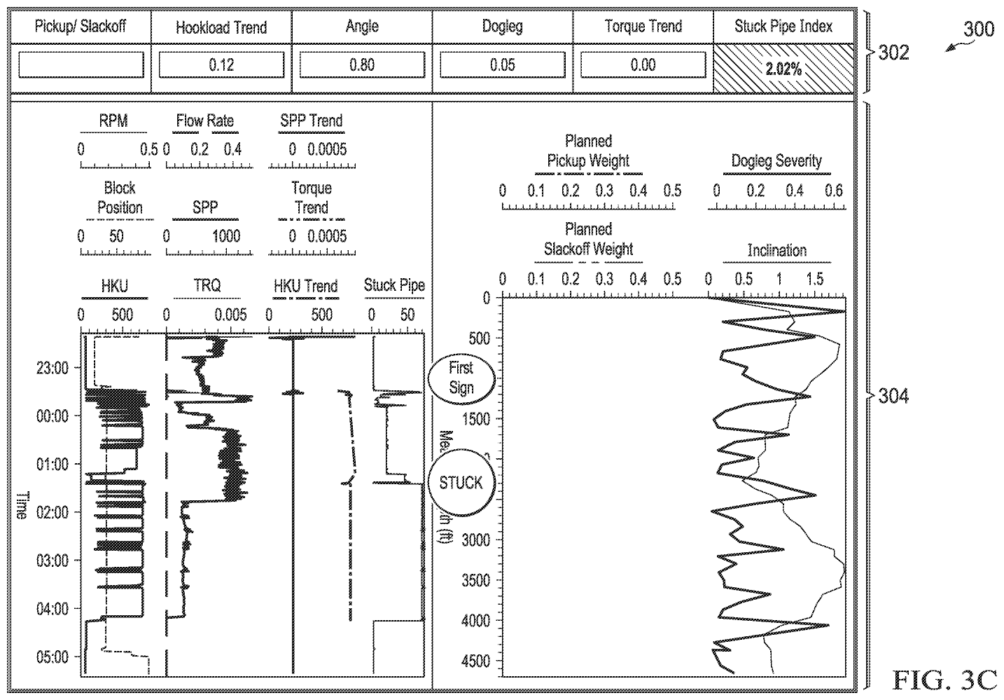

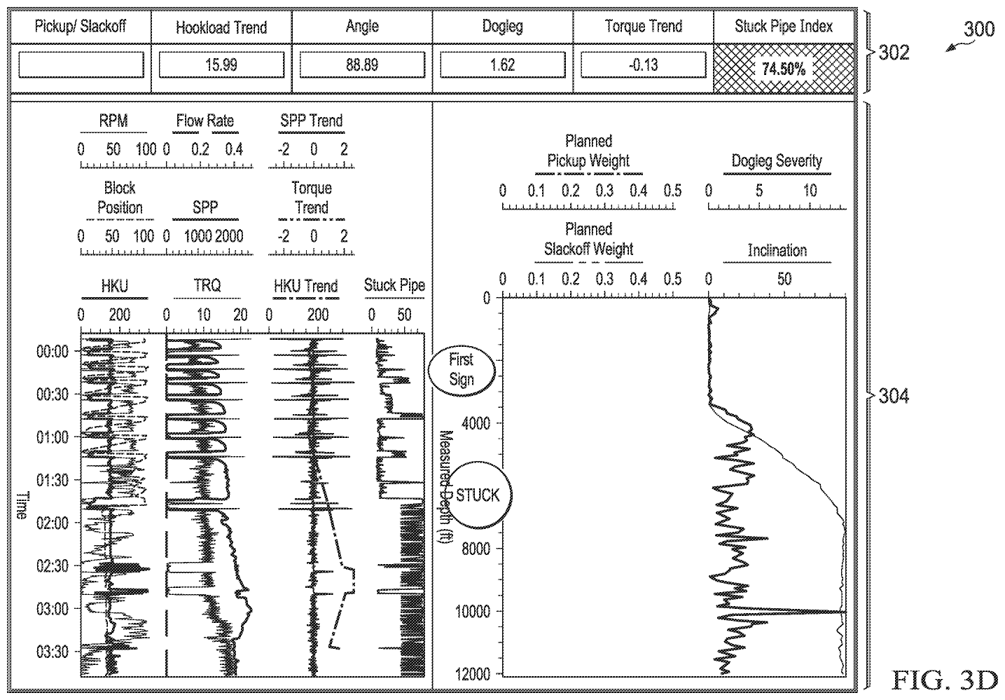

FIGS. 3A-3C shows an example graphical user interface (GUI) 300 for displaying information regarding a drilling process to a user. The GUI 300 can be presented, for example, by any of the computer systems 104a and 104b.

As shown in FIG. 3A, the GUI can include display elements 302 show one or more of the metrics, sub-metrics, measurements, or other data described herein. As an example, the GUI 300 can show the current SPI metric, as well as one or more of the sub-metrics, measurements, or other data used to calculate the SPI metric. Further, the GUI can include display elements 304 showing the change in one or more of the metrics, sub-metrics, measurements, or other data described herein over time. For example, the display elements can include plots or traces that are continuously updated over time to reflect the current values and historical values of the metrics, measurements, or other data (for example, over a sliding time window).

As shown in FIG. 3B, when certain alert criteria are satisfied, the GUI 300 can generate an alert to a user. For example, the GUI 300 can display the SPI metric more prominently, such as highlighting the SPI metric in a particular color (for example, red), blinking the SPI metric, and/or presenting the SPI metric using an enlarged and/or bolded font. This can be useful, for example, in gaining the user's attention, such that the user can take corrective action to avoid a stuck pipe.

As shown in FIG. 3C, when the alert criteria are not long met, the GUI 300 can discontinue the alert. For example, the GUI 300 can display the SPI metric less prominently, such as highlighting the SPI metric in another color (for example, green), discontinuing blinking the SPI metric, and/or presenting the SPI metric using a smaller and/or non-bolded font.

As shown in FIG. 3D, if the alert criteria are again satisfied, the GUI 300 can once against generate an alert to a user.

### Example Processes

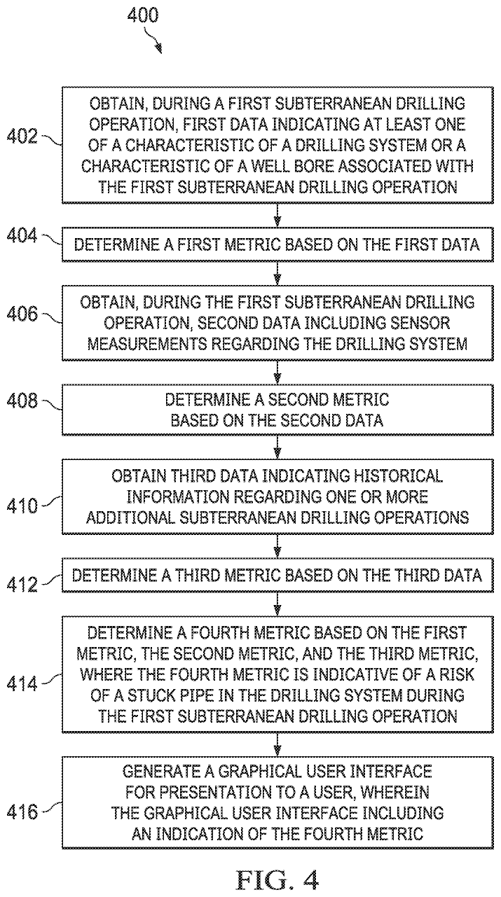

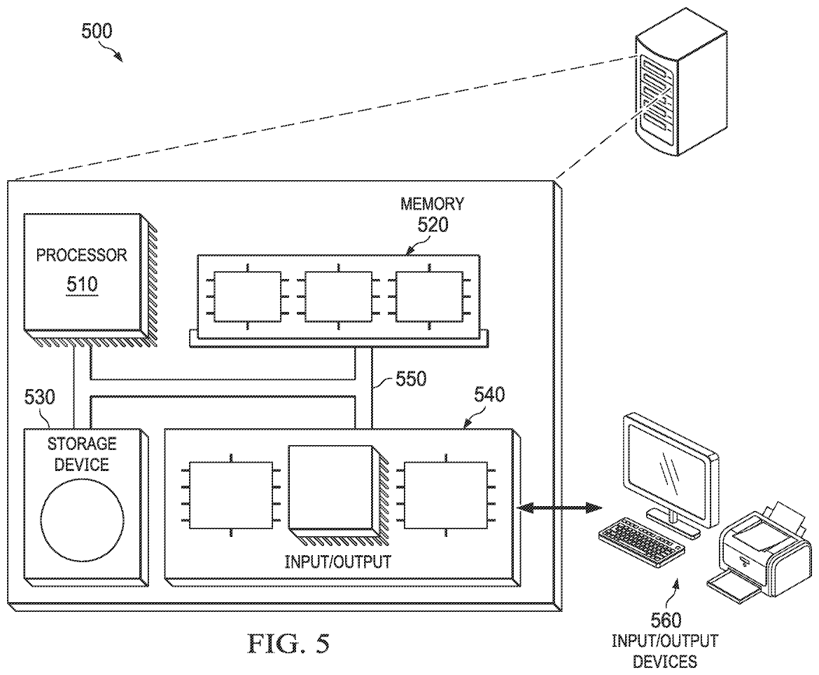

FIG. 4 shows an example process 400 for assessing a risk of a stuck pipe during a well drilling process. In some implementations, the process 400 can be performed by the system 100 described in this disclosure (for example, the system 100 including the drill monitoring system 150 shown and described with respect to FIGS. 1, and 2) using one or more processors (for example, using the processor or processors 510 shown in FIG. 5).

According to the process 400, one or more processors obtain, during a first subterranean drilling operation, first data indicating at least one of a characteristic of a drilling system or a characteristic of a wellbore associated with the first subterranean drilling operation (block 402). The one or more processors determine a first metric based on the first data (block 404). As an example, the first data can include the sensor data 112 and 208a and/or the historical data 122 and 208b. Further, the first metric can include the sub-metric x₁ (for example, representing a “prior risk experience”). Example techniques for calculating the first metric are described above, for example, with reference to the processing rules 208c.

In some implementations, the first data can include one or more of (i) an indication of a trajectory of the wellbore, (ii) an indication of an operational state of a bit drill of the drilling system during the first subterranean drilling operation, or (iii) a location of a drill string of the drilling system during the first subterranean drilling operation. In some implementations, the first data further can include an indication whether the location of the drill string is within one or more pre-determined regions (for example, a particular depth interval beneath the surface of the earth).

The one or more processors obtain, during the first subterranean drilling operation, second data including sensor measurements regarding the drilling system (block 406). The one or more processors determine a second metric based on the second data (block 408). As an example, the second data can include the sensor data 112 and 208a and/or the historical data 122 and 208b. Further, the second metric can include the sub-metric x₂ (for example, representing a “field symptom” risk). Example techniques for calculating the second metric are described above, for example, with reference to the processing rules 208c.

In some implementations, the sensor measurements can include at least one of (i) first measurements indicating a length of time that a string of the drilling system has been stationary during the first subterranean drilling operation, (ii) second measurements indicating a torque generated by the drilling system during the first subterranean drilling operation, (iii) third measurements indicating a drag of the drilling system during the first subterranean drilling operation, (iv) fourth measurements indicating a stand pipe pressure of the drilling system during the first subterranean drilling operation, or (v) fifth measurements indicating a hook load of the drilling system during the first subterranean drilling operation.

In some implementations, determining the second metric can include determining a change in at least one of the second measurement, the third measurement, the fourth measurement, or the fifth measurement over time.

The one or more processors obtain third data indicating historical information regarding one or more additional subterranean drilling operations (block 410). The one or more processors determine a third metric based on the third data (block 412). As an example, the third data can include the sensor data 112 and 208a and/or the historical data 122 and 208b. Further, the third metric can include the sub-metric x₃ (for example, representing a “trouble zone” risk). Example techniques for calculating the third metric are described above, for example, with reference to the processing rules 208c.

In some implementations, the third data can include, for each of the one or more additional subterranean drilling operations: (i) a depth of the additional drilling operation; and (ii) an indication whether a stuck pipe occurred at that depth during the additional drilling operation.

The one or more processors determine a fourth metric based on the first metric, the second metric, and the third metric (block 414). The fourth metric is indicative of a risk of a stuck pipe in the drilling system during the first subterranean drilling operation. As an example, the fourth metric can include the SPI metric, as described above.

In some implementations, the fourth metric can be a weighted sum of the first metric, the second metric, and the third metric.

The one or more processors generate a graphical user interface for presentation to a user (block 414). The graphical user interface includes an indication of the fourth metric. Example graphical user interfaces are shown, for instance, in FIGS. 3A-3D.

In some implementations, the process 400 can also include determining that the fourth metric satisfies one or more alert criteria, and in response, generating an alert using the graphical user interface. In some implementations, the one or more alert criteria can include one or more of (i) a first criterion that the fourth metric exceeds a threshold value for at least a first threshold length of time, (ii) a second criterion that an additional alert has not been generated within a second threshold length of time in the past, or (iii) a third criterion that the first data, the second data, and the third data satisfy a minimum quality threshold.

In some implementations, the first data and the second data can be obtained continuously during the first subterranean drilling operation. In some implementations, the first data and the second data can be obtained in real-time or substantially real-time.

In some implementations, the first metric, the second metric, and the fourth metric can be determined continuously during the first subterranean drilling operation. In some implementations, the first metric, the second metric, and the fourth metric can be determined in real-time or substantially real-time.

### Example Systems

Some implementations of the subject matter and operations described in this specification can be implemented in digital electronic circuitry, or in computer software, firmware, or hardware, including the structures disclosed in this specification and their structural equivalents, or in combinations of one or more of them. For example, in some implementations, one or more components of the system 100 and the drill monitoring system 150 can be implemented using digital electronic circuitry, or in computer software, firmware, or hardware, or in combinations of one or more of them. In another example, the process 400 shown in FIG. 4 can be implemented using digital electronic circuitry, or in computer software, firmware, or hardware, or in combinations of one or more of them.

Some implementations described in this specification can be implemented as one or more groups or modules of digital electronic circuitry, computer software, firmware, or hardware, or in combinations of one or more of them. Although different modules can be used, each module need not be distinct, and multiple modules can be implemented on the same digital electronic circuitry, computer software, firmware, or hardware, or combination thereof.

Some implementations described in this specification can be implemented as one or more computer programs, that is, one or more modules of computer program instructions, encoded on computer storage medium for execution by, or to control the operation of, data processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (for example, multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, for example, an FPGA (field programmable gate array) or an ASIC (application specific integrated circuit). The apparatus can also include, in addition to hardware, code that creates an execution environment for the computer program in question, for example, code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages. A computer program may, but need not, correspond to a file in a file system. A program can be stored in a portion of a file that holds other programs or data (for example, one or more scripts stored in a markup language document), in a single file dedicated to the program in question, or in multiple coordinated files (for example, files that store one or more modules, sub programs, or portions of code). A computer program can be deployed to be executed on one computer or on multiple computers that are located at one site or distributed across multiple sites and interconnected by a communication network.

Some of the processes and logic flows described in this specification can be performed by one or more programmable processors executing one or more computer programs to perform actions by operating on input data and generating output. The processes and logic flows can also be performed by, and apparatus can also be implemented as, special purpose logic circuitry, for example, an FPGA (field programmable gate array) or an ASIC (application specific integrated circuit).

Processors suitable for the execution of a computer program include, by way of example, both general and special purpose microprocessors, and processors of any kind of digital computer. Generally, a processor will receive instructions and data from a read only memory or a random access memory or both. A computer includes a processor for performing actions in accordance with instructions and one or more memory devices for storing instructions and data. A computer can also include, or be operatively coupled to receive data from or transfer data to, or both, one or more mass storage devices for storing data, for example, magnetic, magneto optical disks, or optical disks. However, a computer need not have such devices. Devices suitable for storing computer program instructions and data include all forms of non-volatile memory, media and memory devices, including by way of example semiconductor memory devices (for example, EPROM, EEPROM, AND flash memory devices), magnetic disks (for example, internal hard disks, and removable disks), magneto optical disks, and CD-ROM and DVD-ROM disks. The processor and the memory can be supplemented by, or incorporated in, special purpose logic circuitry.

To provide for interaction with a user, operations can be implemented on a computer having a display device (for example, a monitor, or another type of display device) for displaying information to the user. The computer can also include a keyboard and a pointing device (for example, a mouse, a trackball, a tablet, a touch sensitive screen, or another type of pointing device) by which the user can provide input to the computer. Other kinds of devices can be used to provide for interaction with a user as well. For example, feedback provided to the user can be any form of sensory feedback, such as visual feedback, auditory feedback, or tactile feedback. Input from the user can be received in any form, including acoustic, speech, or tactile input. In addition, a computer can interact with a user by sending documents to and receiving documents from a device that is used by the user. For example, a computer can send webpages to a web browser on a user's client device in response to requests received from the web browser.

A computer system can include a single computing device, or multiple computers that operate in proximity or generally remote from each other and typically interact through a communication network. Examples of communication networks include a local area network (“LAN”) and a wide area network (“WAN”), an inter-network (for example, the Internet), a network including a satellite link, and peer-to-peer networks (for example, ad hoc peer-to-peer networks). A relationship of client and server can arise by virtue of computer programs running on the respective computers and having a client-server relationship to each other.

FIG. 5 shows an example computer system 500 that includes a processor 510, a memory 520, a storage device 530 and an input/output device 540. Each of the components 510, 520, 530 and 540 can be interconnected, for example, by a system bus 550. The processor 510 is capable of processing instructions for execution within the system 500. In some implementations, the processor 510 is a single-threaded processor, a multi-threaded processor, or another type of processor. The processor 510 is capable of processing instructions stored in the memory 520 or on the storage device 530. The memory 520 and the storage device 530 can store information within the system 500.

The input/output device 540 provides input/output operations for the system 500. In some implementations, the input/output device 540 can include one or more of a network interface device, for example, an Ethernet card, a serial communication device, for example, an RS-232 port, or a wireless interface device, for example, an 802.11 card, a 3G wireless modem, a 4G wireless modem, or a 5G wireless modem, or both. In some implementations, the input/output device can include driver devices configured to receive input data and send output data to other input/output devices, for example, keyboard, printer and display devices 560. In some implementations, mobile computing devices, mobile communication devices, and other devices can be used.

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable sub-combination.

A number of embodiments have been described. Nevertheless, various modifications can be made without departing from the spirit and scope of the invention. Accordingly, other embodiments are within the scope of the claims.

What is claimed is:

1. A method comprising:
obtaining, using one or more processors during a first subterranean drilling operation, first data indicating at least one of a characteristic of a drilling system or a characteristic of a wellbore associated with the first subterranean drilling operation;
determining, using the one or more processors, a first metric based on the first data;
obtaining, using the one or more processors during the first subterranean drilling operation, second data comprising sensor measurements regarding the drilling system;
determining, using the one or more processors, a second metric based on the second data;
obtaining, using the one or more processor, third data indicating historical information regarding one or more additional subterranean drilling operations;
determining, using the one or more processors, a third metric based on the third data;
determining, using the one or more processors, a fourth metric based on the first metric, the second metric, and the third metric, wherein the fourth metric is indicative of a risk of a stuck pipe in the drilling system during the first subterranean drilling operation; and
generating, using the one or more processors, a graphical user interface for presentation to a user, wherein the graphical user interface comprises an indication of the fourth metric.

2. The method of claim 1, wherein the fourth metric is a weighted sum of the first metric, the second metric, and the third metric.

3. The method of claim 1, further comprising:
determining, using the one or more processors, that the fourth metric satisfies one or more alert criteria; and
responsive to determining that the fourth metric satisfies the one or more alert criteria, generating an alert using the graphical user interface.

4. The method of claim 3, wherein the one or more alert criteria comprise at least one of:
a first criterion that the fourth metric exceeds a threshold value for at least a first threshold length of time;
a second criterion that an additional alert has not been generated within a second threshold length of time in the past; or
a third criterion that the first data, the second data, and the third data satisfy a minimum quality threshold.

5. The method of claim 1, wherein the first data and the second data are obtained continuously during the first subterranean drilling operation.

6. The method of claim 5, wherein the first metric, the second metric, and the fourth metric are determined continuously during the first subterranean drilling operation.

7. The method of claim 1, wherein the first data comprises at least one of:
an indication of a trajectory of the wellbore;
an indication of an operational state of a bit drill of the drilling system during the first subterranean drilling operation; or
a location of a drill string of the drilling system during the first subterranean drilling operation.

8. The method of claim 7, wherein the first data further comprises:
an indication whether the location of the drill string is within one or more pre-determined regions.

9. The method of claim 1, wherein the sensor measurements comprise at least one of:
first measurements indicating a length of time that a string of the drilling system has been stationary during the first subterranean drilling operation;
second measurements indicating a torque generated by the drilling system during the first subterranean drilling operation;
third measurements indicating a drag of the drilling system during the first subterranean drilling operation;
fourth measurements indicating a stand pipe pressure of the drilling system during the first subterranean drilling operation; or
fifth measurements indicating a hook load of the drilling system during the first subterranean drilling operation.

10. The method of claim 9, wherein determining the second metric comprises determining a change in at least one of the second measurement, the third measurement, the fourth measurement, or the fifth measurement over time.

11. The method of claim 1, wherein the third data comprises, for each of the one or more additional subterranean drilling operations:
a depth of the additional drilling operation; and
an indication whether a stuck pipe occurred at that depth during the additional drilling operation.

12. A system comprising:
one or more processors; and
one or more non-transitory computer readable media storing instructions that, when executed by the one or more processors, cause the one or more processors to perform operations comprising:
obtaining, during a first subterranean drilling operation, first data indicating at least one of a characteristic of a drilling system or a characteristic of a wellbore associated with the first subterranean drilling operation;
determining a first metric based on the first data;
obtaining, during the first subterranean drilling operation, second data comprising sensor measurements regarding the drilling system;
determining a second metric based on the second data;
obtaining third data indicating historical information regarding one or more additional subterranean drilling operations;
determining a third metric based on the third data;
determining a fourth metric based on the first metric, the second metric, and the third metric, wherein the fourth metric is indicative of a risk of a stuck pipe in the drilling system during the first subterranean drilling operation; and
generating a graphical user interface for presentation to a user, wherein the graphical user interface comprises an indication of the fourth metric.

13. One or more non-transitory computer readable media storing instructions that, when executed by one or more processors, cause the one or more processors to perform operations comprising:
obtaining, during a first subterranean drilling operation, first data indicating at least one of a characteristic of a drilling system or a characteristic of a wellbore associated with the first subterranean drilling operation;
determining a first metric based on the first data;
obtaining, during the first subterranean drilling operation, second data comprising sensor measurements regarding the drilling system;
determining a second metric based on the second data;
obtaining third data indicating historical information regarding one or more additional subterranean drilling operations;
determining a third metric based on the third data;
determining a fourth metric based on the first metric, the second metric, and the third metric, wherein the fourth metric is indicative of a risk of a stuck pipe in the drilling system during the first subterranean drilling operation; and
generating a graphical user interface for presentation to a user, wherein the graphical user interface comprises an indication of the fourth metric.
